(19) United States
(12) Patent Application Publication
(10) Pub. No.: US 2025/0111561 A1
(43) Pub. Date: Apr. 3, 2025

(54) GUIDED MULTI-STAGE DIFFUSION SYSTEM AND A METHOD TO GENERATE GRAPHICAL DATASETS

(71) Applicant: UNAR Labs, LLC, Portland, ME (US)

(72) Inventor: Owen Thompson, Portland, ME (US)

(73) Assignee: UNAR Labs, LLC, Portland, ME (US)

(21) Appl. No.: 18/902,648

(22) Filed: Sep. 30, 2024

Related U.S. Application Data
(60) Provisional application No. 63/587,452, filed on Oct. 3, 2023.

(51) Int. Cl. G06T 11/20; G06F 16/26; G06T 11/60

(52) U.S. Cl. CPC G06T 11/206; G06F 16/26; G06T 11/60

(57) ABSTRACT

Embodiments of the present invention provide a method and system for procedural generation of synthetic diffusion-augmented graphical data set. The system is based on Artificial Neural network (ANN) that is trained to generate graphics in form of mathematical graphs. The system utilizes a pre-trained diffusion network and does not need retraining. The system comprises a graphical dataset in the pre-trained diffusion network and is capable of synthesizing all of its source data from the graphical dataset. The graphics are generated by a graphic generation engine which is implemented using traditional image processing and scalable vector graphics (SVG).

### CROSS_REFERENCE TO RELATED APPLICATION

The present application claims the benefit of U.S. provisional Patent Application Ser. No. 63/587,452, filed Oct. 3, 2023, entitled “Procedural Generation of Diffusion-Augmented Graphical Datasets”, the details of which are hereby incorporated by reference as if fully set forth herein in their entirety.

### TECHNICAL FIELD

The present invention relates to assistive technology, and more particularly to a system and a method that aids visually impaired individuals and AI agents to perceive graphical information, such as digital documents, web pages, websites, and social media sites. The system and method involve procedures for generating synthetic datasets used in training models for precise labelling, components extraction and graphics representation.

### BACKGROUND ART

A visually impaired (VI) person has impaired eyesight and has difficulty perceiving and/or observing not-textual images residing on a screen, permanently or temporarily. The situation-induced impairment or disability includes limited-light environment, social setting that demands eyes-free information access, emergency management, stealth military operations, manipulation of the infotainment system while driving. In these situations, the person wishes to gain information from an image (or any graphical information) through non-visual access.

The conventional available technologies enable VI individuals to access visual graphic contents via a combination of one or more of haptic and auditory representations. The traditional methods use Artificial Intelligence (AI) models to extract and combine textual and non-textual information in the document, questions for formulating answers or achieving other tasks, such as recognition, captioning, and semantic understanding. The Artificial General Intelligence (AGI) models (such as CLIP) have attained a high degree of understanding of natural image content; however, they lack performance in mathematical graphs.

There are various factors that limit the performance of conventional AGI model on mathematical graphs, such as lack of representation of such datasets in internet-scrubbed data, lack of appropriate semantic information for mathematical or scientific graphs, lack of focus on accessibility and understanding of the semantics needed for making the graphics accessible. Stable diffusion, DALL.E and other image generation model can create images form a text prompt, however, fine-grained control over the content of the image is hard to achieve. For instance, the text or numbers generated on the graph often do not conform to standard bar-graph semantic.

Another conventional image generation model is ControlNet, which uses an open-source AI Diffusion technology implementation. The model leverages Diffusion, an image-generation procedure that is typically highly unpredictable. ControlNet provides the user the capacity to control Diffusion by training the generation on lower representations of image components, such as edges or rudimentary illustrations so that it allows the enforcement of superficial structure on outputs. However, it precisely lacks the kind of control needed when making the training data for graph interpretation. ControlNet uses a neural network architecture with two sets of weights connected by a zero-convolution layer. One set of weights is a locked copy of the large pre-trained diffusion model while the other set is trainable and uses the additional conditioning input.

The present invention provides a method that enables control over the image generation output while using the power of diffusion or other similar ANNs capable of image inpainting. The process involves generating the components in layers, with precise labelling and masking during rendering to prevent adverse effects on appearance. The present invention does not leverage retraining and instead engineer the Diffusion process into separate steps under which varying levels of control can be enforced to influence the data generation. The implementation is more conducive to retain precise graphical information that otherwise would be changed by an undirected diffusion pipeline of graph generation.

### SUMMARY OF THE INVENTION

According to a first aspect of the present invention, a system for generating a graphical dataset is provided. The system comprising: a graph structure generation module to generate a graph structure using one or more components and layout in a semi-randomized manner; a mask generation module to mask one or more features in the graph structure; a diffusion module configured to use a diffusion technique to generate a realistic image of the one or more components and layout of the graph structure; and a merge layer module to merge a plurality of the realistic image of the one or more components and layout of the graph structure to generate a final graph image.

In one embodiment of the invention, the system further comprising a metadata generation module that creates a ground truth file containing a metadata information of the graph structure.

In one embodiment of the invention, the metadata information is saved in a json file for information on position, text content and numeric data, and in SVG files for contour information, and in PNG file for image mask information.

In one embodiment of the invention, the system further comprising an augmentation module that applies one or more variations in the final graph image.

In one embodiment of the invention, the one or more variations include scaling, warping or contrast variation in the final graph image.

In one embodiment of the invention, the one or more components and layout of the graph structure includes type of graph, lines, point, axis, tick-mark, keys, text, bars information inside each of the graph structure.

In one embodiment of the invention, the mask generation module protects a text label information of the graph structure by masking the text label information.

In one embodiment of the invention, the one or more components and layer of the graph structure is selected from a pre-trained graphical dataset.

In one embodiment of the invention, the system uses a pre-defined constraints on parameter ranges or values of the one or more components and layer.

According to a second aspect of the present invention, a method for generating a graphical dataset is provided. The method comprising: identifying one or more parameters of a graph structure and identifying constraints for one or more component and layer of the graph structure in a semi-randomized manner; providing a mask on the one or more components and layer of the graph structure to prevent overlapping of one or more features of the one or more components and layer; generating a scalable vector graphic file for the one or more components and layer of the graph structure; applying a diffusion technique to generate a realistic image of the one or more component and layer of the graph structure; and merging a plurality of realistic image of the one or more component and layers of the graph structure to generate a final graph image.

In one embodiment of the invention, the method further comprising: generating a masked scalable vector graphic file from the scalable vector graphic file to extract a metadata information.

In one embodiment of the invention, the metadata information of the one or more components and layer of the graph structure is stored in a ground truth file.

In one embodiment of the invention, the metadata information comprises one or more ground truth information that includes but is not limited to position, text content, numeric data.

In one embodiment of the invention, the metadata information comprises contour information of the graph structure.

In one embodiment of the invention, the method further comprising: applying one or more variation in the final graph image, the one or more variations include but is not limited to scaling, warping or contrast variation.

In one embodiment of the invention, the one or more components and layout of the graph structure include type of graph, lines, point, axis, tick-mark, keys, text, bars information inside each of the graph structure.

In one embodiment of the invention, the one or more components and layer of the graph structure is selected from a pre-trained graphical dataset.

In the context of the specification, the phrase “unstructured data” refers to the data that does not follow a predefined schema or format and can vary significantly in length and content. Some of the examples of unstructured data include text documents, images, audio recordings, video recording and sensor data.

In the context of the specification, the phrase “structured data” refers to the data organized in accordance with a predefined schema. The structured data conforms to a data model and predefined rules on how the data is represented (for example, data types, field lengths). Furthermore, data elements within a structured database can have defined relationships with one another. Some of the examples of the structured data include databases, spreadsheets, XML or JSON objects, and web forms.

In the context of the specification, the phrase “Artificial Neural Network (ANN)” refers to an autonomously acting computer program designed to perceive its environment, make decisions, and take actions to achieve a goal or a set of goals. The ANN may further be equipped with data-gathering and learning (reinforcement learning, supervised learning, or unsupervised learning) capabilities.

In the context of the specification, the phrase “training” refers to technique that use deep learning techniques to understand, generate, and manipulate human language. ANN are trained on relatively large amounts of data that allow them to identify complex patterns and relationships between words. ANN are generally equipped with several capabilities such as Natural Language Processing (NLP), Text Generation, Question Answering, Dialogue, and Summarization.

In the context of the specification, the phrase “module” as used herein refers to any known or later developed hardware, software, firmware, artificial intelligence, fuzzy logic, or combination of hardware and software that is capable of performing the functionality associated with that element. Also, while the disclosure is presented in terms of exemplary embodiments, it should be appreciated that individual aspects of the disclosure can be separately claimed.

In the context of the specification, the phrase “JavaScript Object Notation (JSON)” refers to a format used for storing and exchanging structured data. It is based on JavaScript Object syntax but is language-independent. A JSON object can contain data represented as key-value pairs, nested objects, and arrays, and written as plain text.

In the context of the specification, the term “processor” refers to one or more of a microprocessor, a microcontroller, a general-purpose processor, a Field Programmable Gate Array (FPGA), a Graphics Processing Unit (GPU), a Neural Processing Unit (NPU), a Tensor Processing Unit (TPU), an Application Specific Integrated Circuit (ASIC), and the like.

In the context of the specification, the phrase “memory unit” refers to volatile storage memory, such as Static Random Access Memory (SRAM) and Dynamic Random Access Memory (DRAM) of types such as Asynchronous DRAM, Synchronous DRAM, Double Data Rate SDRAM, Rambus DRAM, and Cache DRAM, etc.

In the context of the specification, the phrase “storage device” refers to a nonvolatile storage memory such as EPROM, EEPROM, flash memory, or the like.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

FIG. 1 is a block diagram illustrating a system for generation of synthetic diffusion-augmented graphical dataset in accordance with an embodiment of the present invention.

FIG. 2 is a flow chart illustrating the method for the generation of synthetic diffusion-augmented graphical dataset in accordance with an embodiment of the present invention.

FIG. 3 illustrates a process for generating a Ground Truth Image file and a Ground Truth Metadata for training the system in accordance with an embodiment of the present invention.

FIG. 4 illustrates a diffusion isolation procedure adopted in the Image generation module or the diffusion module to control the operation of subsequent merge layer module in accordance with an embodiment of the present invention.

FIG. 5 illustrates one or more adjustments in the system for preserving the quality of the text content rendered in the generated image in accordance with an embodiment of the present invention.

FIG. 6 shows an example of generating graphical dataset using random graphic parameters in accordance with an exemplary embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

The terms “a” and “an” herein do not denote a limitation of quantity, but rather denote the presence of at least one of the referenced items. The terms “having”, “comprising”, “including”, and variations thereof signify the presence of a component.

Embodiments of the present invention discloses a method and system for procedural generation of a synthetic diffusion-augmented graphical data set. The system is based on an Artificial Neural network (ANN) that is trained to generate graphics in form of mathematical graphs. The system utilizes a pre-trained diffusion network and does not need retraining. The system comprises a graphical dataset in the pre-trained diffusion network and is capable of synthesizing all of its source data from the graphical dataset. The values in the graphics are randomly generated numbers sampled from random distribution. The random distributions include boundaries of shape, lines and graphs. The random distributions are tailored to fall within reasonable ranges found in a typical graphics. The graphics are generated by a graphic generation engine which is implemented using traditional image processing and scalable vector graphics (SVG). The graphic generation engine utilizes scalable vector graphics (SVG) for drawing of lines and characters. The data is then paired with a mask that prevents the destruction of its structural elements that correspond with interpretation of its underlying data. Diffusion is applied using in-painting through the mask. A plurality of image layers are then combined to form a combined image.

The system comprises a plurality of processing modules. The system uses a guided multi-stage diffusion process to conform to limitations of generation that preserve the meaning of graphical information, and introduce common image characteristics using diffusion. The graphical dataset in the pre-trained system can be used to provide precise labels for any graphics. The system is configured to turn an image into an SVG or JSON structure which is suitable for translation for a blind user.

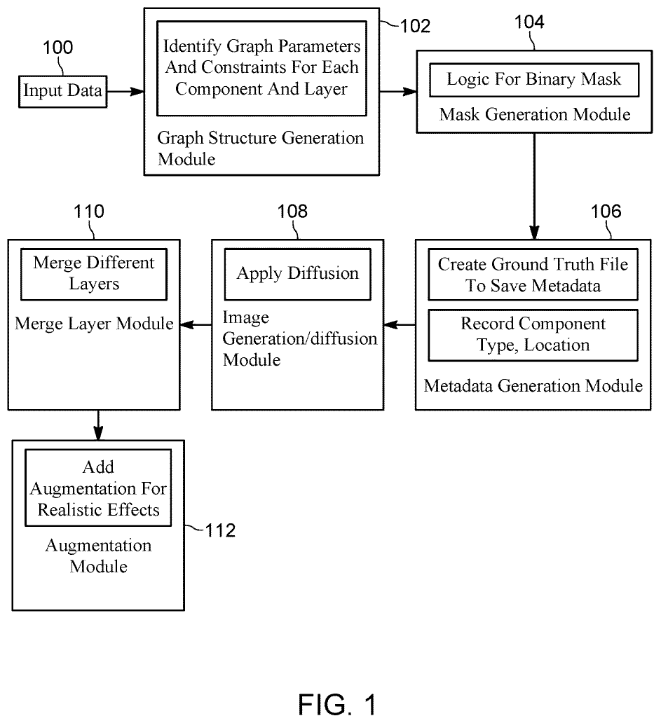

FIG. 1 is a block diagram illustrating a system for generation of synthetic diffusion-augmented graphical dataset in accordance with an embodiment of the present invention. The system comprises a graph structure generation module 102, a mask generation module 104, a metadata generation module 106, an image generation or diffusion module 108, a merge layers module 110, and an augmentation module 112.

The graph structure generation module identifies the input data 100. The graph structure generation module 102 defines the components and their layout for a type of graphs, such as bar chart, line chart, geometric figures etc. in a semi-randomized manner using pre-defined constraints on parameter ranges or values. The graph structure generation module 102 leverages the versatility of the open SVG format to create graphics with high variability and known configuration parameters for things like the locations of lines, text, shapes, or points. The graph structure generation module 102 uses randomized axis, line, bar, and label information to generate figures with precise control over the positions of the lines, grids, points, axis, tick-marks, keys, text, bars, etc. inside each figure. The graph structure generation module 102 uses a wide range of potential content prevalent in the training data and adjusted the data to reflect real data and/or common failure points for extraction.

The Mask Generation module 104 encapsulates the logic for binary masks based on rendering order of the components and overlap criteria. Some components can have overlap, but text labels need to be in front and non-overlapped with other text or lines. As components are rendered, some masks are recomputed to enforce such constraints. The mask generation module 104 ensures that the generation pipeline can be tweaked to preserve component features to the extent needed from inadvertent effects of image generation models like stable diffusion.

The Metadata Generation module 106 creates the ground truth files that save all the metadata for generation. The ground truth files can be distilled to generate training datasets that use the generated synthetic images. The metadata is saved in json files for ground truth information such as, position, text content, and numeric data. SVG files are used to save contour information for re-rendering. Image masks are also saved as PNG files for potential usage in building AI models for automation of graphical interpretation.

The Image Generation module or the Diffusion module 108 consists of one or more Image generation Foundation models, such as, Stable Diffusion, DALL.E. etc. The image generation module 108 has engineered prompts to generate realistic images of different components or apply variations in the background that correspond to scanned images of graphs. The image generation module 108 uses diffusion process to craft top-tier artwork from an input image.

The Merge Layers module 110 encapsulates the logic to merge the generated components with selective masking to control the quality of the output.

The Augmentation module 112 applies minor image-based augmentations such as scaling, warping or contrast variations to the generated images without altering the information content in the image.

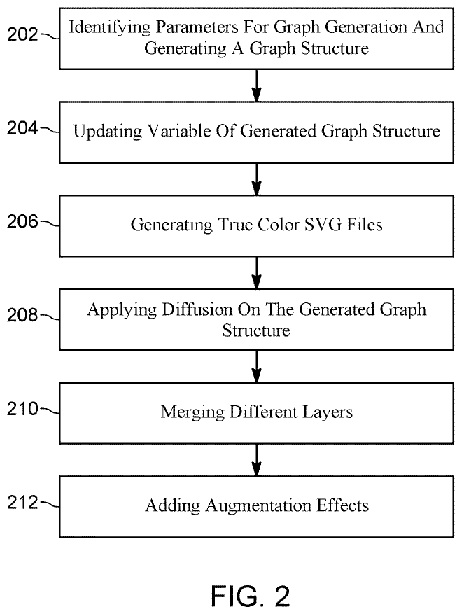

FIG. 2 is a flow chart illustrating the method for the generation of synthetic diffusion-augmented graphical dataset in accordance with an embodiment of the present invention. In the first step 202, a graph structure is generated. The graph structure generation module identifies parameters for graph generation, such as components and their layout for a type of graph (bar chart, line chart, geometric figures). The constraints for each component and layer of the graphs are identified and randomized parameters, such as colors are inserted in the graph. The process is done in a semi-randomized manner using pre-defined constraints on parameters range or values. The constraints and parameters are taken from a pre-trained graphical dataset. The axis, line, bar, and label information are used randomly from the pre-trained dataset to generate figures with precise control over the position of the lines, grids, points, axis, tick-marks, keys, texts, bars etc. inside the figure. The constraints and parameters are chosen to reflect the variance of real graphical datasets.

In the next step 204, the variables of the generated graph structure are updated. This step uses the masking process to protect essential component features. The first layer is not masked; any subsequent layer is masked to preserve the essential component or variables. The update logic-update variable is used to regenerate masks so they do not overlap for certain components like text. The mask generation module performs the function of masking different layers of the generated graph.

In the next step 206, a true-color scalable vector graphic file is generated, and the file is converted to mask-SVG file, where the color is swapped to black and white. In this step, a ground truth file is generated that save all the metadata for generation of graphic image. The ground truth file can be distilled to generate training dataset. The metadata is saved in json files for ground truth information, such as location of axis, grid, tick-markers, text location of the bars and all text. The SVG files are used to save contour information for re-rendering.

In the next step 208, the diffusion process is applied to the generated graph to generate realistic image of different components or apply variation in background that corresponds to the scanned image of the graphs. The diffusion is not applied to the text and diffusion parameters in the graphs are randomized and a prompt is generated to apply diffusion process to the graph to generate realistic image.

In the next step 210, the diffused layers of the previous steps are merged to control the quality of the output image. In this step, mask is transformed by adding blurring or other features to the mask. The previous layer is replaced and the new component diffused in the graph are kept.

In step 212, augmentations are added to the output image to provide realistic effects. The augmentation process may include effects, such as scaling, warping, rotation or contrast variations to the generated image without altering the information content in the image.

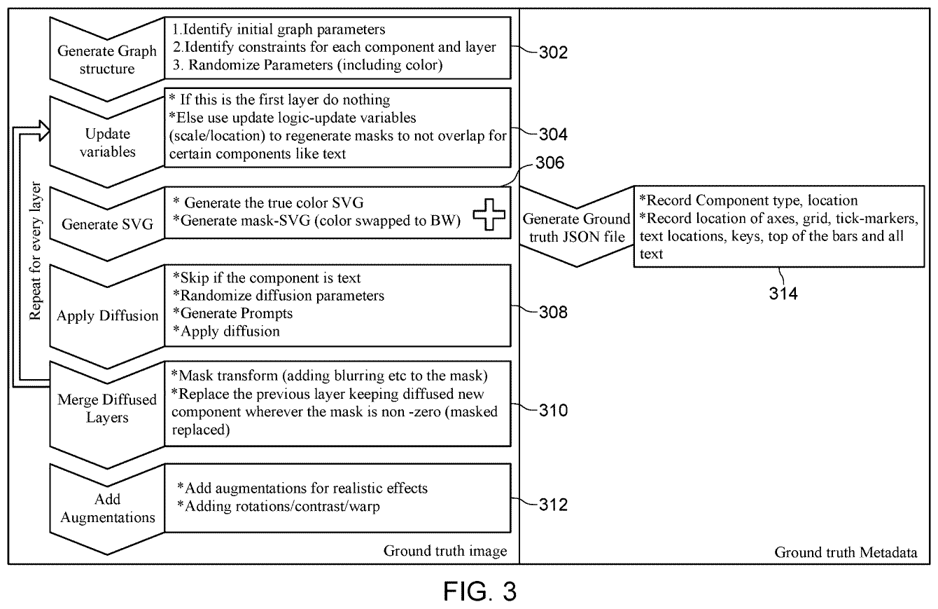

FIG. 3 illustrates a process for generating a Ground Truth Image file and a Ground Truth Metadata for training the system in accordance with an embodiment of the present invention. In step 302, a graph structure is generated. The step 302 involves: a) identifying initial graph parameters, b) identifying constraints for each component and layer; c) Randomize parameters.

In next step 304, variables are updated. The first layer of the generated graph structure is kept as such. For any subsequent layer, update logic-update variables (scale/location) is used to regenerate masks to not overlap for certain components like text.

In step 306, scalable graphic vector file is generated. The step involves generating true color SVG file and generating masked-SVG file. The metadata of SVG file is stored in form of a ground truth JSON file which is stored as ground truth metadata 314 for training the graphical dataset. The ground truth JSON file record data, such as component type, location, and record location of axis, grid, tick-markers, text locations, keys, top of the bar and all text.

In next step 308, diffusion is applied to the generated SVG files of step 306. While applying diffusion, the text component is skipped, and diffusion parameters are randomized. A prompt is generated and the diffusion is applied.

In step 310, diffused layers are merged. The step involves: mask transform (adding blurring etc. to the mask) and replacing the previous layer, keeping diffused new component wherever the mask is non-zero (masked replacement).

Steps 304, 306, 308 and 310 are repeated for every layer of the generated graph structure to arrive at the output image.

In step 312, augmentations are added to the output image of step 310. The augmentation involves adding augmentation to provide realistic effects to the final image. The augmentation comprises adding rotation, contrast enhancement, or adding warp.

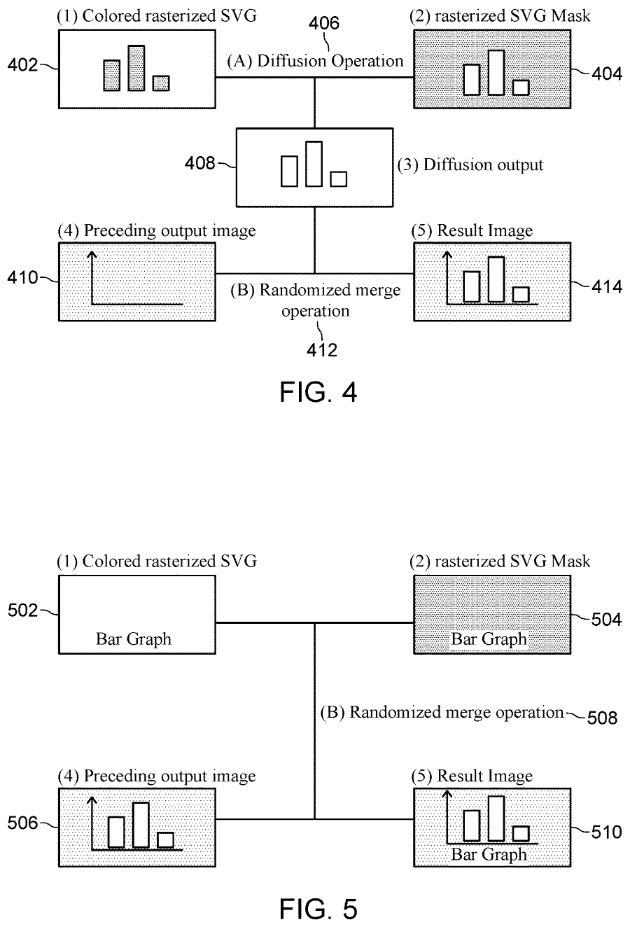

FIG. 4 illustrates a diffusion isolation procedure adopted in the Image generation module or the diffusion module to control the operation of subsequent merge layer module. The primitive traditional randomly generated content image 402 is diffused with a rasterized SVG content mask 404 using a masked diffusion process 406 in order to introduce relevant artifacts and details to the masked region. A diffusion output image 408 is generated, which is a partially diffused intermediate output. The masked diffusion process 406 randomly introduces image artifacts and nebulous themes like contrast, gradients, noise or superfluous markings like folds, stains or shadows present in real figure, which is difficult to add with traditional random image generation heuristically. The masked image ensures that the underlying data in the graph is not altered and the diffusion process is non-destructive to the label generation pipeline. The mask limits the diffusion step bounds. The diffusion output image 408 is then merged with a preceding output image or background layer 410 using randomized merge operation 412. In the randomized merge operation 412, the layers are combined using traditional image processing techniques, such as stitching, blending or merging. The randomized merge operation 412 generates a result image 414 in form of a realistically varied graph with precise labels for training models for information extraction from graphs.

FIG. 5 illustrates one or more adjustments in the system for preserving the quality of the text content rendered in the generated image in accordance with an embodiment of the present invention. The primitive traditional randomly generated content image 502 is used to generate a rasterized SVG image 504 with specific regions masked from any changes. The rasterized SVG image 504 is merged with a preceding output image 506 using a randomized merge operation 508. The randomized merge operation 508 generates a result image 510 in form of a realistically varied graph with precise labels for training models for information extraction from graphs. The process is followed in the instance of text content insertion.

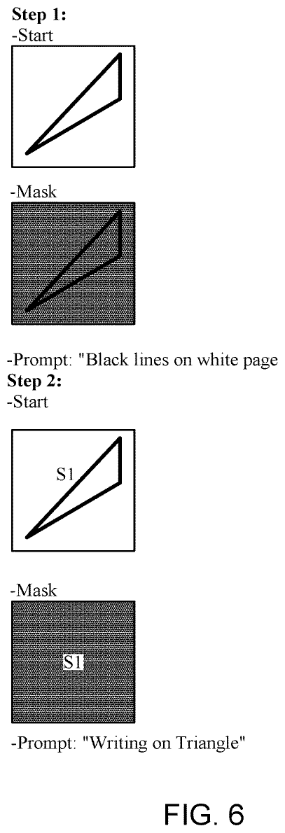

FIG. 6 shows an example of generating graphical dataset using random graphic parameters in accordance with an exemplary embodiment of the present invention. The example shows generating a graph for random Points: ‘[(01.5, 0.85), (0.88, 0.12), (0.9, 0.41)]’ with Labels: ‘[“Si”, null, null]’. In step 1, the process starts with identifying random parameters from graphical dataset and identifying constraints for each layer and component. Multiple layer of graphics are generated and regions are masked. The masked diffusion is performed on the masked graphic layer. In step 2, text is inserted in the graphic for labelling the generated graphs. The graphic is then masked to prevent any important information that could otherwise change the meaning of the graphic. The diffusion is then applied to the graphics, merging different layers to generate an output image. Augmentation effect is then added to the output image to provide realistic effects.

The main advantage of the present invention is that the system uses a guided multi-stage diffusion process to conform to limitations of generation that preserve the meaning of graphical information while introducing common image characteristics using diffusion.

Another advantage of the present invention is that the system is capable of synthesizing all of its source data and uses a pre-trained diffusion network without any retraining.

Another advantage of the present invention is that the system has a graphic regeneration engine implemented using traditional image processing and scalable vector graphics (SVG) as a backbone.

Although specific advantages have been enumerated above, various embodiments may include some, none, or all of the enumerated advantages.

Other technical advantages may become readily apparent to one of ordinary skill in the art after review of the instant specification.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to be providing the broadest scope consistent with the principles and the novel and inventive features disclosed or suggested herein. Accordingly, the invention is anticipated to hold on to all other such alternatives, modifications, and variations that fall within the scope of the present invention.

1. A system for generating a graphical dataset, the system comprising:
a graph structure generation module to generate a graph structure using one or more components and layout in a semi-randomized manner;
a mask generation module to mask one or more features in the graph structure;
a diffusion module configured to use a diffusion technique to generate a realistic image of the one or more components and layout of the graph structure; and
a merge layer module to merge a plurality of the realistic image of the one or more components and layout of the graph structure to generate a final graph image.

2. The system of claim 1 further comprising a metadata generation module that creates a ground truth file containing a metadata information of the graph structure.

3. The system of claim 2, wherein the metadata information is saved in a json file for information on position, text content and numeric data, and in SVG files for contour information, and in PNG file for image mask information.

4. The system of claim 1 further comprising an augmentation module that applies one or more variations in the final graph image.

5. The system of claim 4, wherein the one or more variations include scaling, warping or contrast variation in the final graph image.

6. The system of claim 1, wherein the one or more components and layout of the graph structure includes type of graph, lines, point, axis, tick-mark, keys, text, bars information inside each of the graph structure.

7. The system of claim 1, wherein the mask generation module protects a text label information of the graph structure by masking the text label information.

8. The system of claim 1, wherein the one or more components and layer of the graph structure is selected from a pre-trained graphical dataset.

9. The system of claim 1, wherein the system uses a pre-defined constraints on parameter ranges or values of the one or more components and layer.

10. A method for generating a graphical dataset, the method comprising:
identifying one or more parameters of a graph structure and identifying constraints for one or more component and layer of the graph structure in a semi-randomized manner;
providing a mask on the one or more components and layer of the graph structure to prevent overlapping of one or more features of the one or more components and layer;
generating a scalable vector graphic file for the one or more components and layer of the graph structure;
applying a diffusion technique to generate a realistic image of the one or more component and layer of the graph structure; and
merging a plurality of realistic image of the one or more component and layers of the graph structure to generate a final graph image.

11. The method of claim 10 further comprising: generating a masked scalable vector graphic file from the scalable vector graphic file to extract a metadata information.

12. The method of claim 11, wherein the metadata information of the one or more component and layer of the graph structure is stored in a ground truth file.

13. The method of claim 11, wherein the metadata information comprise one or more ground truth information that includes but is not limited to position, text content, numeric data.

14. The method of claim 11, wherein the metadata information comprises contour information of the graph structure.

15. The method of claim 10 further comprising: applying one or more variation in the final graph image, the one or more variation includes but is not limited to scaling, warping or contrast variation.

16. The method of claim 10, wherein the one or more components and layout of the graph structure includes type of graph, lines, point, axis, tick-mark, keys, text, bars information inside each of the graph structure.

17. The method of claim 10, wherein the one or more components and layer of the graph structure is selected from a pre-trained graphical dataset.
